(19) United States
(12) Patent Application Publication
(10) Pub. No.: US 2001/0005952 A1
(43) Pub. Date: Jul. 5, 2001

(54) Advertising display device

(76) Inventor: Marc Bruneel, Brasschaat (BE)

Correspondence Address: BACON & THOMAS, PLLC, 4th Floor, 625 Slaters Lane, Alexandria, VA, 22314, US

(21) Appl. No.: 09/728,124

(22) Filed: Dec. 4, 2000

(30) Foreign Application Priority Data
Dec. 3, 1999 (FR) 9915302

(51) Int. Cl. G09F 7/00

(52) U.S. Cl. 40/605

(57) ABSTRACT

An advertising display device, comprising a housing, said housing having longitudinal faces and end faces, whereby one of the longitudinal faces constitutes a front face with an advertising window, the device further comprising means for moving a strip comprising advertising images past said window, wherein the advertising display device is equipped with transport means which are provided at one or more or said longitudinal faces. The housing may be provided with a front edge frame and a top cap ending up at said edge frame.

### FIELD OF THE INVENTION

The present invention relates to an advertising display device in the form of a housing, whereby the front face thereof has an advertising window, which device further comprises means for moving a strip comprising advertising images past said window.

More particularly, the advertising display device according to the present invention is destined for being disposed in series with other similar devices, one in the prolongation of the other, at the edges of sports-grounds, for presenting advertising messages, however, it is obvious that this device may also be used on its own, in other words, in a solitary manner, or serve for other purposes than advertisement, in other words, for displaying information of non-advertising character.

### BACKGROUND OF THE INVENTION

It is known to equip advertising display devices with retractable transport handles which are mounted at the end faces of the device.

An example of an advertising display device with such retractable handles is described in the French patent No. 2,705,816. The disadvantage of this known device consists of the fact that, when such device has to be removed in respect to other adjacent devices, the handles are not accessible, which results in a practically impossible handling of the device.

In view of the importance of a fast intervention on any module during a match, it is obvious that the possible removal without having to displace the other devices will have to be performed with the shortest-possible delay and with minimum means.

### SUMMARY OF THE INVENTION

The present invention has as an object to avoid said inconvenience and to provide an advertising display device which can be handled in an easy manner when the device is used in series with one or several similar devices, thereby also forming a presentation row.

To this aim, the invention relates to an advertising display device of the aforementioned type, comprising handling means which are provided at least at one of the longitudinal faces of the device, in such a manner that those transport means are always accessible.

In a preferred form of embodiment of the invention, said handling means consist at least of one handle, for example, of hinged nature, which, also preferably, are situated at the rear face of the housing of the advertising display device. It is obvious that the housing can be provided with several handles, thereby enhancing the handling of the device.

According to a preferred characteristic of the invention, the device further comprises end faces, realized in such a manner that this device can be removed from a row of similar devices without the necessity of displacing the adjacent devices.

According to another particular characteristic of the invention, the connecting means between the aligned advertising display devices are situated at the rear faces of the housings of two adjacent devices.

The invention also relates to an advertising display device which is particularly stable and which, in a preferred embodiment, allows to provide a protective element at, more particularly in front of, the advertising window in a relatively simple manner.

Therefore, the invention also relates to an advertising display device comprising a housing, the front face of which shows an advertising window, as well as means for moving a strip past the window, which strip comprises the images to be advertised, whereby the aforementioned housing, apart from the aforementioned front face, further comprises a rear face, two end faces, an upper face and a bottom face, and whereby at least the upper face is provided with a top cap, characterized in that the housing, at least nearby the foremost upper edge, is provided with an edge frame, preferably a fixed edge frame, and in that the top cap ends up at the edge frame.

An advantage of such edge frame consists in that the housing becomes additionally reinforced at the front side and at the same time is more resistant against shocks, impacts, etc.

Due to the fact that, according to the present invention, the top cap no longer overlies the front side of the uppermost roll and, furthermore, ends up at the edge frame, it is excluded that the top cap can bend at its foremost edge and come into contact with the strip comprising the images to be advertised.

Another advantage consists in that the edge frame offers the possibility of providing a protective element at the advertising window, more particularly in front of this advertising window. In existing devices, for example, as described in U.S. Pat. No. 5.557,868, the use of such protective element is quite difficult because of the fact that such devices are provided with a top cap having a front portion which overlies the upper roll of the advertising mechanism, whereby this front portion mostly is not sufficiently stable for fixing such protective element thereto.

The aforementioned protective element may be of any kind, and hereby a transparent element may be intended, such that the advertised information is visible through this element, as well as a non-transparent element which then is intended to be provided as a protection when the advertising device is not in use. The protective element may consist of a plate, but can also be made of a flexible sheet, a foil, or the like.

In an analogous manner, an edge frame can also be formed at the lower front edge of the housing, having a profile to which, if necessary, the aforementioned protective element can be attached.

Preferably, the protective element is removable. Usually, in this kind of devices, the advertising images are printed on posters, which posters are attached to the aforementioned strip. By using a protective element which is removable, the strip still remains accessible, so that the posters can be exchanged, without the necessity of any further dismantling of the device.

Of course, the aforementioned characteristics, such as, for example, the use of handles at the longitudinal faces, on one hand, and the use of an edge frame at the foremost upper edge and/or lower edge, on the other hand, may be combined or not.

### BRIEF DESCRIPTION OF THE DRAWINGS

In order to better explain the present invention, several examples of embodiments of the invention are described hereafter, by way of example and not being limitative, whereby reference is made to the accompanying drawings, wherein:

FIG. 1 in perspective represents the advertising display device according to the invention;

FIG. 2, also in perspective, represents the rear side of the device of FIG. 1;

FIG. 3, at a larger scale, represents the part indicated by F3 in FIG. 2;

FIG. 4 represents a cross-section according to line IV-IV in FIG. 3;

FIG. 5 represents a rear view of several advertising display devices, mounted in the prolongation of each other;

FIG. 6, at a larger scale, represents the part indicated by F6 in FIG. 5;

FIG. 7, at a larger scale, represents a cross-section according to line VII-VII in FIG. 6;

FIG. 8, in perspective, represents a connecting element which can connect two devices according to the invention, indicated by F8 in FIG. 7;

FIG. 9 represents a rear view of several advertising display devices, during assembly;

FIG. 10 schematically represents a cross-section according to line X-X in FIG. 9;

FIG. 11, in cross-section, represents a variant of the invention;

FIGS. 12 and 13, at a larger scale, represent views of the portions indicated by F12 and F13 in FIG. 11;

FIG. 14 represents a view of the housing of the device of FIG. 11 in perspective;

FIGS. 15 to 18 represent views analogous to that of FIG. 11, however, in different phases of mounting;

FIGS. 19 to 22 represent views analogous to those of FIGS. 15 to 18, for another variant of the invention, also for different phases of mounting.

### DETAILED DESCRIPTION

The advertising display device 1 comprises a housing, having a front face 2 in which a window 3 is realized; a rear face 4; upper and lower faces 5 and 6, respectively; and two end faces 7 and 8.

Said housing is provided with means 9 which can move a strip 10 showing the images to be displayed, more particular, advertising images, past said window 3.

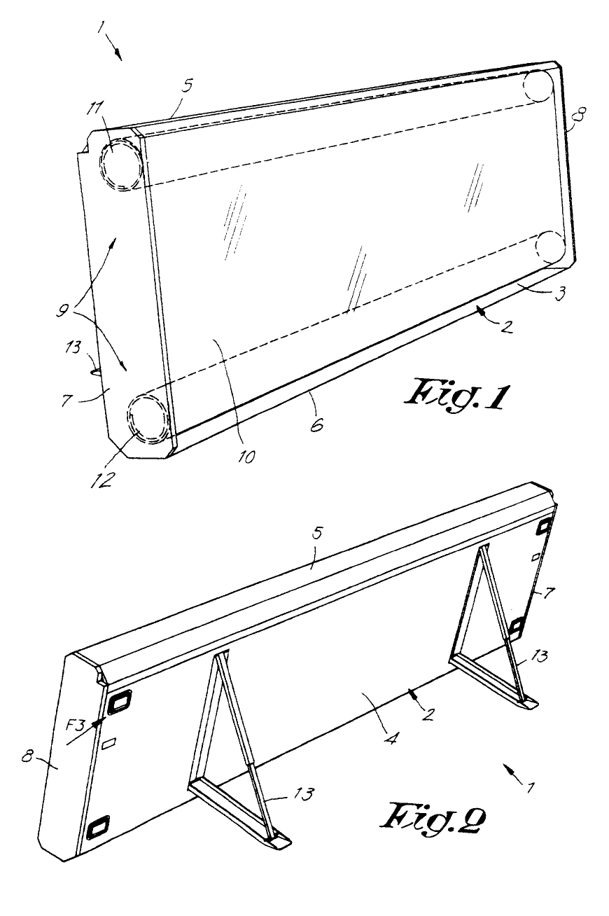

In the embodiment according to FIG. 1, the means 9 substantially are composed of rolls 11-12 provided with not-represented driving means, for example, electric motors, which allow to move the strip 10 past said window 3, whereby the strip is transported alternately from one of the rolls 11-12 to the other in an intermittent manner.

It is obvious that the advertising display device 1 will also be provided with driving means for operating the device in an appropriate manner, possibly in a manner synchronized with other devices.

As represented in FIG. 2, the advertising display device 1 is equipped with support means, consisting of swing-out feet 13 allowing to put the device in a stable manner onto any ground and, if necessary, to realize the inclination of the advertising display device 1.

Each corner of the rear face 4 of the advertising display device 1 is provided with a transport means 14, consisting of a swing-out handle 15.

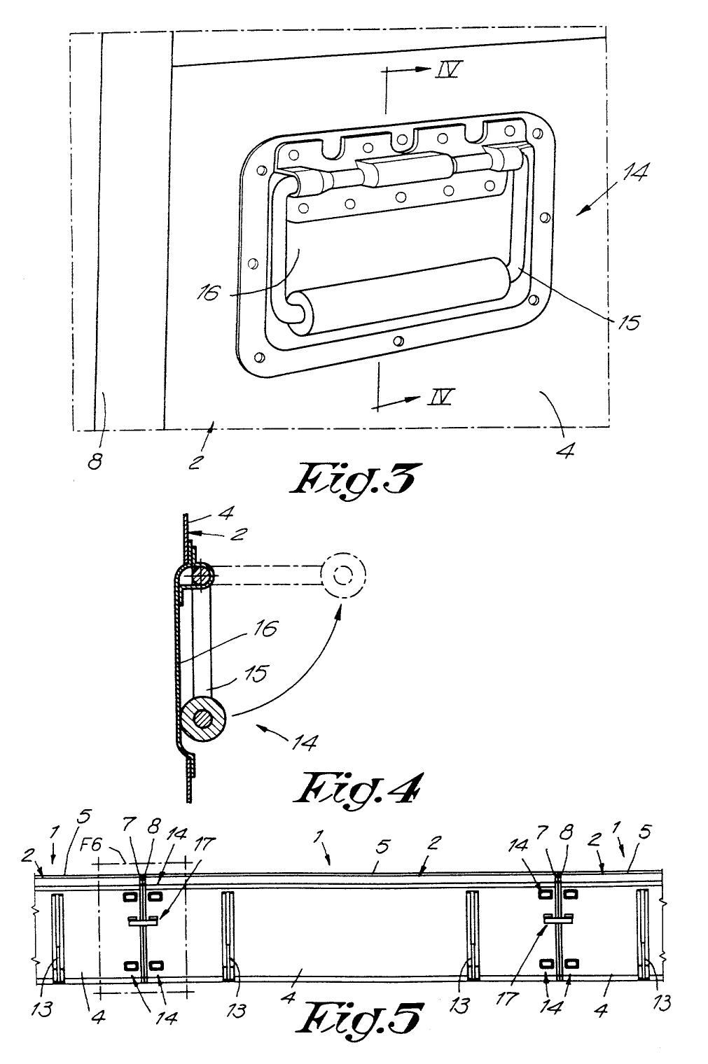

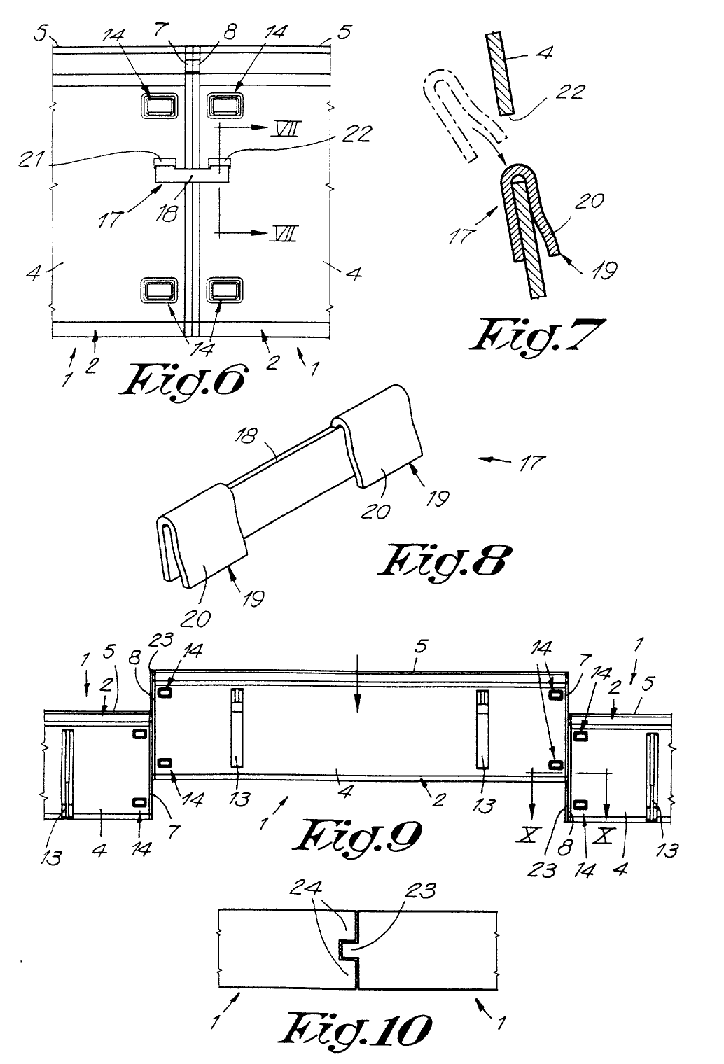

As represented more detailed in FIGS. 3 and 4, such swing-out handle consists of a pivoting bow, which, in rest position, can be located in a cavity 16 which, to this effect, is provided in said rear face 4, probably under the influence of non-represented pull-back springs.

An advertising display device 1 according to the invention may be coupled to other similar devices by means of connecting means 17 in order to realize a row of advertising display devices, such as represented in FIG. 5, which, for example, allows to display advertising messages longer than the length of a single advertising display device 1.

Each connection means 17 consists of a rod 18 with, at each extremity, a portion 19 forming two hooks 20 which can engage into openings 21 and 22 in said rear faces 4 of two adjacent advertising display devices 1.

The installation of an advertising display device 1 according to the invention is realized in the manner as described hereafter.

In order to connect advertising display devices 1 according to the invention, several of such advertising display devices 1 are disposed such that their end faces 7-8 are situated adjacent to each other, which is facilitated by the presence of the swing-out handles 15.

Subsequently, the different advertising display devices 1 are connected to each other by inserting the hooks 20 of the connecting means 17 into the openings 21-22 of the adjacent advertising display devices.

It is obvious that the advertising display devices can easily be disconnected from each other and removed one by one, this by first removing said connection means 17.

It is clear that the connecting means 17 can be realized in any different suitable manner, for example, such as represented schematically in FIGS. 9 and 10.

In this example, those connection means 17 comprise a male part 23, provided at one of the extremities of an advertising display device 1, and a female part 24 at the other extremity, such that these parts 23 and 24 of two adjacent devices can cooperate with each other. These parts 23-24 allow for the connection of two adjacent devices by means of a vertical movement of one housing in respect to the other.

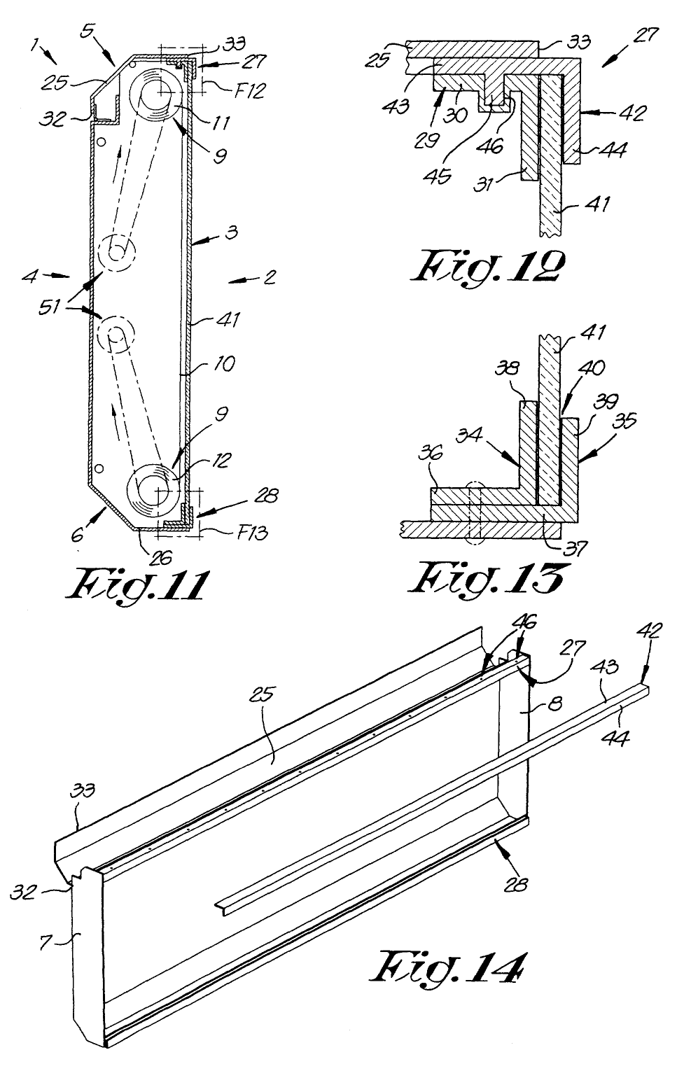

In FIGS. 11 to 18, a variant of an advertisement display device 1 according to the invention is represented schematically. Analogous to the aforementioned forms of embodiment, this advertisement display device 1 is provided with a housing which, in a classic manner, comprises a front face 2 in which an advertising window 3 is provided, a rear face 4, two end faces 7-8, a upper face 5 and lower face 6.

The upper face 5 is provided with a top cap 25 which can be swung open, whereas the lower face 6 is formed by a fixed lower portion 26 which is made in one piece with the rear face 4.

A particular characteristic of this form of embodiment consists in that at least at the foremost upper edge, and in this case, at the foremost upper edge as well as at the foremost lower edge, additional edge frames 27 and 28, respectively, are provided.

The edge frame 27 of the upper edge is formed by a profile 29, more particularly an L-shaped profile which is fixed between the end faces 7-8, with a horizontal flange 30, situated at the height of the upper side of the device, and a vertical flange 31 situated at the front of the device.

The top cap 25 is connected to the rear face 4 in a hinged manner and extends from its hingeing edge 32 in order to end up with its opposite edge 33 against the edge frame 27. Hereby, this cap 25 overlies exclusively the rear side and upper side of the roll 11.

In this case, the edge frame 28 of the lower edge is formed by two L-shaped profiles 34-35, with horizontal flanges 36-37 which are situated one above the other, and vertical flanges 38-39, which are situated in the proximity of the front face of the housing and which are located at a small distance from each other, such that in between a seat 40 is formed, the purpose of which will become clear from the further discription.

It is clear that, according to a more simple form of embodiment, the edge frame 28 also might consist of one separate profile 34 or 35, whereas the other profile 35 or 34 is replaced by an edge portion formed in one piece with the plate of the lower face 6 of the device.

Further, the advertising display device 1 of FIGS. 11 to 18 is provided with a protective element which can be provided in front of the strip 10 and which, in this case, consists of a transparent sheet or plate 41, for instance, of plexiglass. At its lower edge, this plate 41 is fixed in the seat 40 and at the top is kept at its place by means of a fixation profile 42 which is fixed on the profile 29. This fixation profile 42 is also made in an L-shape and shows a horizontal flange 43, which is provided with fixation means at its under side with which means said profile 42 can be fixed on the profile 29, and a vertical flange 44 fitting over the upper edge of the plate 41.

In the represented example, said fixation means consist of pins 45 which are provided at the underside of flange 43 and which, in mounted condition, engage into openings or seats 46 in flange 30 of profile 29.

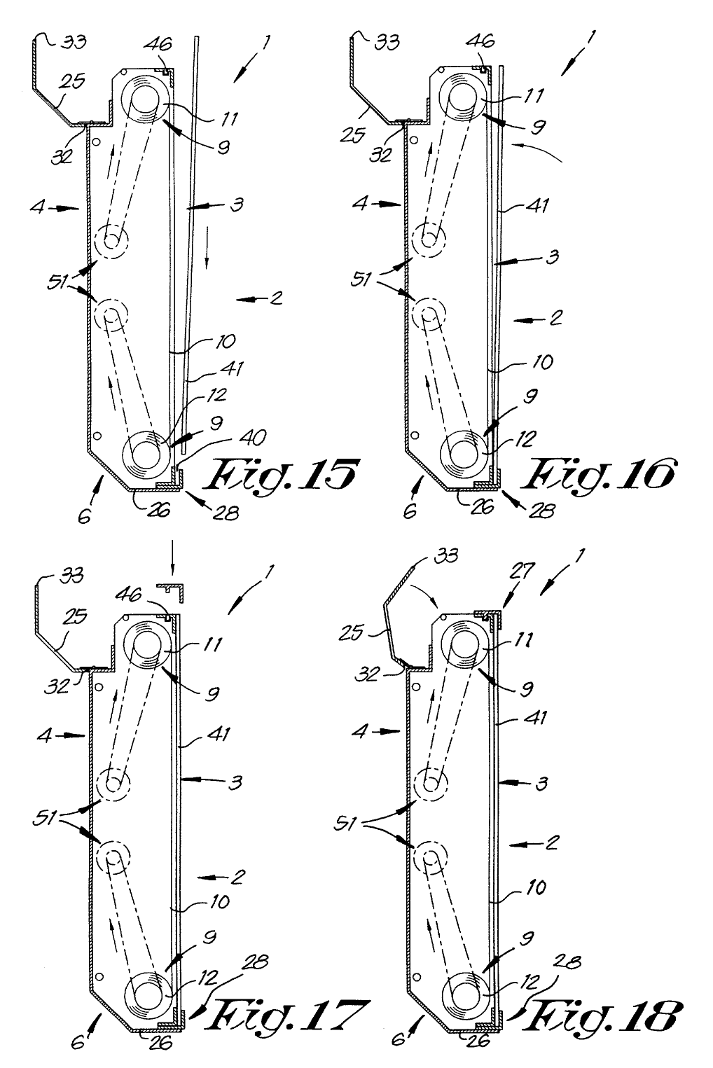

The installation of the plate 41 can easily be derived from FIGS. 15 to 18. As represented in FIGS. 15 and 16, the plate 41 first is shifted into the seat 40. Subsequently, the plate 41 is brought into contact with the profile 29, after which, as represented in FIG. 17, the profile 42 is fixed on the profile 29. Finally, only the top cap 25 has to be pivoted downward, as schematically indicated in FIG. 18.

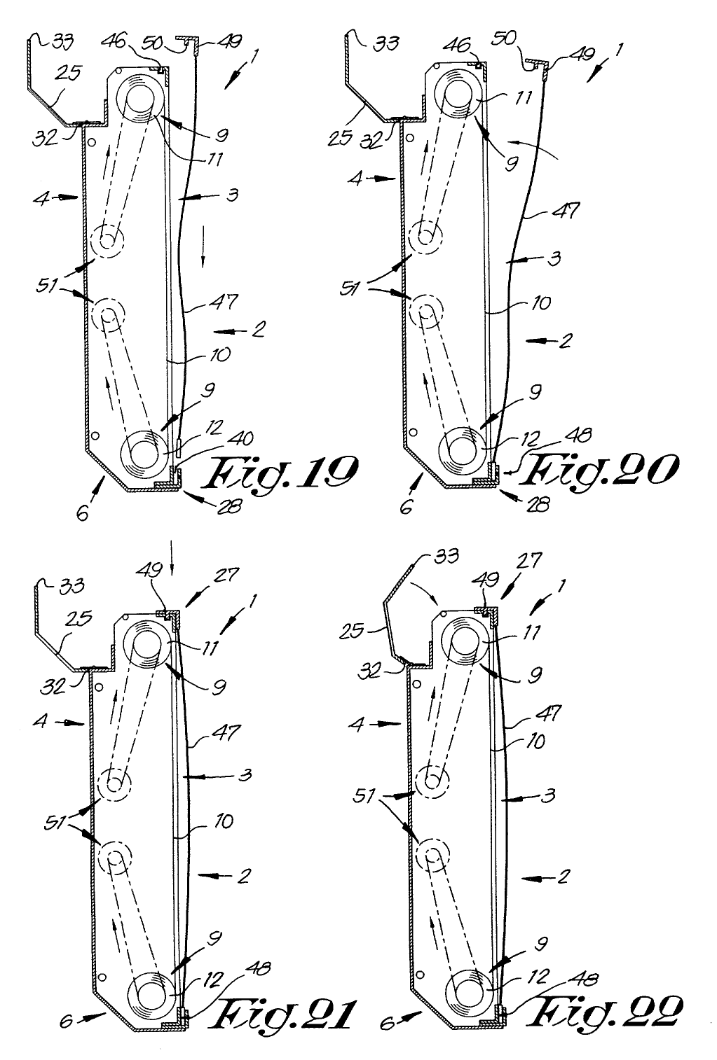

In FIGS. 19 to 22, a variant is represented whereby the protective element consists of a relatively flexible sheet or foil 47 which can be fixed below at the edge frame 28, by means of pins or screws 48 and which at the top is provided with a profile 49 which in this case is permanently fixed to the sheet 47. This profile 49 is provided with fixation means, such as pins 50, which can cooperate with the aforementioned openings 46.

The protective element is installed in the manner as described hereafter. First, as represented in FIGS. 19 and 20, the sheet 47 is placed with its lower edge into the seat 40 and fixed therein by means of the pins or screws 48. Subsequently, the sheet 47 is fixed at its upper edge by engaging the profile 49 at the profile 29, as a result of which a condition is obtained, as represented in FIG. 21. Subsequently, only the top cap 25 has to be swung down, as indicated in FIG. 22.

It is obvious that the protective element can also be fixed in other manners than described in the aforegoing. So, for example, use can be made of snap-on systems instead of connections by means of pins and openings.

Furthermore, it should be noted that one device may also be equipped with two or more protective elements, which can be exchanged or which can be used in combination. For example, such device may be provided with a plate 41 of plexiglass, whereas it may also be provided with a protective sheet 47 which, for example, is not transparent. During use, only the plate 41 is provided at the advertising window, whereas during transport, the flexible sheet 47 is installed in front of the plate 41, in order to protect the latter against damages, such as scratches or the like.

For clearness' sake, in FIGS. 11 to 22 also the drive 51 for the rolls 11-12 is represented schematically. It is self-evident that such drive 51 can be realized in different manners. As such drives as such are sufficiently known from the state of the art, they will not be described in greater detail.

The characteristics of the different forms of embodiments can be combined at random. So, for example, may the device of FIGS. 1 to 3 be provided with edge frames 27-28 and a top cap 25 as described with reference to FIGS. 11 to 22.

It is obvious that the invention is in no way limited to the forms of embodiment described heretofore and represented in the accompanying drawings, but that a plurality of modifications can be applied to the advertising display device without leaving the scope of the invention.

1. An advertising display device, comprising a housing, said housing having longitudinal faces and end faces, whereby one of the longitudinal faces constitutes a front face with an advertising window, the device further comprising means for moving a strip comprising advertising images past said window, wherein the advertising display device is equipped with transport means which are provided at one or more of said longitudinal faces.

2. An advertising display device according to claim 1, wherein said transport means substantially consist of hinged handles.

3. An advertising display device according to claim 1, wherein said transport means are provided at the rear side of said housing.

4. An advertising display device according to claim 1, wherein said transport means comprise at least two handles, said handles respectively being situated in the proximity of the distal ends of said housing.

5. An advertising display device according to claim 4, wherein said housing is provided with at least two handles which are situated at the rear side of said housing, in the upper portion of this rear side.

6. An advertising display device according to claim 1, wherein said transport means comprise at least four handles which are each situated in a corner of the rear face of the housing.

7. An advertising display device according to claim 1, wherein it is configured as a module destined to be disposed with other such modules in mutual prolongation in order to form an advertising assembly.

8. An advertising display device according to claim 7, the end faces thereof being realized in such a manner that the device, when disposed between two other similar, adjacent devices, can be removed from the adjacent devices without the necessity of displacing the latter.

9. An advertising display device according to claim 8, said device further being equipped with connecting means which allow to couple adjacent devices.

10. An advertising display device according to claim 9, wherein the connecting means comprise at least an element which can cooperate with the rear faces of the housings of two adjacent devices.

11. An advertising display device according to claim 9, wherein the connecting means comprise locking parts sliding into each other which allow for connecting two adjacent devices by means of a vertical movement of one housing in respect to the other.

12. An advertising display device according to claim 1, said housing comprising an upper face provided with a top cap, whereby the housing, at least at the foremost upper edge, is provided with an edge frame, said top cap ending up at the edge frame.

13. An advertising display device according to claim 12, the device further comprising a protective element which can be provided at the advertising window, such that it extends between, on one hand, an edge frame provided at the lower edge of the housing and, on the other hand, the aforementioned edge frame provided at the upper edge of the housing.

14. An advertising display device comprising a housing, the front face of which shows an advertising window, as well as means for moving a strip past the window, which strip comprises the images to be advertised, whereby the aforementioned housing, apart from the aforementioned front face, further comprises a rear face, two end faces, an upper face and a bottom face, and whereby at least the upper face is provided with a top cap, characterized in that the housing, at least nearby the foremost upper edge, is provided with an edge frame, and that the top cap ends up at the edge frame.

15. An advertising display device according to claim 14, the device further comprising a protective element which can be provided at the advertising window, such that it extends between, on one hand, an edge frame provided at the lower edge of the housing and, on the other hand, the aforementioned edge frame provided at the upper edge of the housing.

16. An advertising display device according to claim 15, wherein the protective element is removable.
